(19) United States
(12) Patent Application Publication
(10) Pub. No.: US 2019/0347598 A1
(43) Pub. Date: Nov. 14, 2019

(54) SYSTEM AND METHOD FOR EVALUATING THE PERFORMANCE OF A PERSON IN A COMPANY

(71) Applicant: Trigger Transformation, LLC, Baltimore, MD (US)

(72) Inventors: Gerard E. SANDUSKY, Sparks, MD (US); Lisa D. FIRST-WILLIS, Baltimore, MD (US); Kenneth Andrew MCCORD, Waterford, VA (US)

(21) Appl. No.: 16/409,485

(22) Filed: May 10, 2019

Related U.S. Application Data
(60) Provisional application No. 62/669,894, filed on May 10, 2018.

(51) Int. Cl. G06Q 10/06

(52) U.S. Cl. CPC G06Q 10/06398; G06Q 10/06393

(57) ABSTRACT

An employee evaluation system that provides a series of domains that have one or more sub-domains associated therewith. The sub-domain can have one or more questions associated therewith. The system user can input data by answering the questions associated with each domain. The questions can be weighted differently such that the evaluation score associated with each question can differ relative to each other. The employee evaluation system can generate or determine an overall evaluation score with can be a sum of the individual evaluation scores associated with each question. The total evaluation score of the employee can fall within one of a plurality of categories. Each category can have a recommended action associated therewith, and such recommended actions are driven by leveraging data science over a large-scale data asset to recognize employee patterns, predict employee outcomes, and better guide management responses.

### RELATED APPLICATION

This application claims priority to provisional patent application Ser. No. 62/669,894, filed on May 10, 2018, and entitled SYSTEM AND METHOD FOR DETERMINING VALUE OF A PERSON TO AN ORGANIZATION, the contents of which are herein incorporated by reference.

### BACKGROUND OF THE INVENTION

The present invention relates to human resource software and systems, and more specifically relates to human resource software and systems for allowing human resource personnel to assess employee performance in real time.

Conventional human resource management or information systems typically assist personnel in a human resource department of an organization in managing people. The conventional software systems are typically used by businesses to combine a number of necessary human resource functions, such as storing employee data, managing payrolls, managing the recruitment process, benefits administration, keeping track of attendance records, and managing employees through feedback. The conventional systems ensure that every day human resource processes are manageable, easy to access, and relatively easy to understand.

A drawback of conventional human resource management systems, especially as applied to assessing the performance of employees, is that they are difficult to manage and complete, and are used sparingly over the course of a calendar year. Further, conventional systems are typically managed by the human resource department of the organization. As such, personnel who are typically quite busy with other tasks are also responsible for collating and managing job performance information of employees that do not report directly to them.

Another drawback of conventional systems is that they are incapable of properly assessing or quantifying the value of a person to the organization.

### SUMMARY OF THE INVENTION

An object of employee evaluation system of the present invention is to timely and accurately assess a person's strengths and weaknesses, as well as assessing, determining and/or quantifying the value of a person to the organization, utilizing data science and artificial intelligence to recognize employee patterns, predict employee outcomes, and better guide management responses.

The present invention is directed to an employee evaluation system that provides a series of domains that have one or more sub-domains associated therewith. The sub-domain can have one or more questions associated therewith. The system user can input data by answering the questions (e.g., sub-domains) associated with each domain. The questions can be weighted differently such that the evaluation score associated with each question can differ relative to each other. The employee evaluation system can generate or determine an overall evaluation score which can be a sum of the individual evaluation scores associated with each question. The total evaluation score of the employee can fall within one of a plurality of categories. Each category can have a recommended action associated therewith.

The present invention focuses the performance management topic to the most prevalent organizational opportunities by leveraging data science over a large-scale data asset. The system empowers the next generation manager by providing actionable guidance to drive performance improvements while leveraging artificial intelligence to recognize employee patterns and development opportunities for both the manager and the employee.

The underlining data science engine that forms part of the system of the present invention relies on the signal collection of all entities involved in the performance development process, i.e. industry, company, department, manager, employee, assessment, and the like. A series of engineered data features are crafted, analyzed and monitored. These influence the performance of and maturation of the system of the present invention, which are focused on bringing precision and recall accuracy to the predictive capabilities surrounding future performance, developmental areas, industry differentials and company employee and culture health projections.

The employee evaluation system of the present invention can include an employee assessment unit for allowing a user to input through an input device evaluation data about or concerning an employee and for determining an evaluation score associated with the employee based on the inputted evaluation data. The employee assessment unit can include a domain unit for providing a plurality of domains, wherein each of the plurality of domains includes a plurality of sub-domains, wherein each of the sub-domains has at least one pre-determined question associated therewith such that each of the plurality of domains has a plurality of pre-determined questions associated therewith, and wherein each of the pre-determined questions has a selected scoring weight associated therewith, such that the domain unit determines via a processor an evaluation score associated with each of the pre-determined questions based on the evaluation data inputted by the user and the scoring weight associated with the question.

The employee assessment unit can also include an accumulation unit for accumulating the evaluation scores generated by the domain unit to determine via the processor an overall evaluation score, and a categorization unit for associating the overall evaluation score generated by the accumulation unit with one of a plurality of employee categories, wherein each of the plurality of employee categories has a selected action associated therewith.

The system can also include a client electronic device having the input device for allowing the user to input the evaluation data into the employee assessment unit, and a display unit for displaying at least the plurality of domains and the plurality of sub-domains.

The evaluations cores can be generated or determined by any selected component of the employee assessment unit, such as for example by the accumulation unit rather than the domain unit. In this regard, the domain unit transmits the employee data associated with each question to the accumulation unit, which in turn generates the evaluation scores.

The scoring weight associated with each of the pre-determined questions can be different between at least two of the plurality of pre-determined questions. For example, a first one of the pre-determined questions has a first scoring weight associated therewith, and a second one of the plurality of pre-determined questions has a second scoring weight associated therewith, where the first scoring weight is different than the second scoring weight.

According to another practice, the employee evaluation system of the present invention can include a plurality of domains comprising a first (e.g., Performance) domain having one or more questions associated with the work performance of the employee (e.g., work output of the employee, quality of work product of the employee, ability to meet key performance indicators of the employee, or efficiency of work of the employee); a second (e.g., Attitude) domain having one or more questions associated with behavioral aspects of the employee; and a third (e.g., Maintenance) domain having one or more questions associated with management of the employee and/or compensation level.

Further, the plurality of categories can include a first category directed to employees with the total evaluation score in a first scoring range, a second category directed to employees with a total evaluation score in a second scoring range where the first scoring range is greater than the second scoring range, a third category directed to employees with a total evaluation score in a third scoring range where the second scoring range is greater than the third scoring range, a fourth category directed to employees with a total evaluation score in a fourth scoring range where the third scoring range is greater than the fourth scoring range, and a fifth category directed to employees with a total evaluation score in a fifth scoring range, where the fourth scoring range is greater than the fifth scoring range. The action associated with the first category includes promoting the employee or providing increased remuneration to the employee; wherein the action associated with the second category includes notifying the employee of their relative value to a company; wherein the action associated with the third category includes recommending the employee for professional development activities; wherein the action associated with the fourth category includes generating a performance improvement plan for the employee; and wherein the action associated with the fifth category includes replacing the employee.

The employee evaluation system of the present invention can also include an adjustment and prediction unit for adjusting the scoring weight associated with one or more questions based on data from the employee assessment unit and based on one or more evaluation parameters.

The present invention also is directed to a method, implemented by a computing device, comprising providing a plurality of domains, wherein each of the plurality of domains includes a plurality of sub-domains, wherein each of the plurality of sub-domains has at least one pre-determined question associated therewith such that each of the plurality of domains has a plurality of pre-determined questions associated therewith, and wherein each of the pre-determined questions has a selected scoring weight associated therewith. The method further includes allowing a user to input via an input device evaluation data of an employee in response to the plurality of pre-determined questions, determining via a processor an evaluation score associated with each of the plurality of pre-determined questions based on the evaluation data inputted by the user and the scoring weight associated with each of the plurality of questions, determining via the processor an overall evaluation score of the employee from the evaluation scores of the plurality of domains, associating the overall evaluation score with one of a plurality of employee categories, wherein each of the plurality of employee categories has a selected action associated therewith, and displaying via a display unit at least the plurality of domains and the plurality of sub-domains.

The method also includes determining an overall evaluation score of the employee from the evaluation scores of the plurality of domains comprises accumulating the evaluation scores associated with the plurality of pre-determined questions to determine the overall evaluation score. The scoring weight associated with each of the plurality of pre-determined questions is different between at least two of the plurality of pre-determined questions.

The method of the present invention can also include adjusting the scoring weight associated with one or more questions based on data from the employee assessment unit and based on one or more evaluation parameters.

The present invention is also directed to a non-transitory storage medium storing instructions that cause a processor to provide a plurality of domains, wherein each of the plurality of domains includes a plurality of sub-domains, wherein each of the plurality of sub-domains has at least one pre-determined question associated therewith such that each of the plurality of domains has a plurality of pre-determined questions associated therewith, and wherein each of the pre-determined questions has a selected scoring weight associated therewith. The processor also allows a user to input evaluation data of an employee in response to the plurality of pre-determined questions, determine an evaluation score associated with each of the plurality of pre-determined questions based on the evaluation data inputted by the user and the scoring weight associated with each of the plurality of questions, determine an overall evaluation score of the employee from the evaluation scores of the plurality of domains, and associate the overall evaluation score with one of a plurality of employee categories, wherein each of the plurality of employee categories has a selected action associated therewith.

The processor is also configured to accumulate the evaluation scores associated with the plurality of pre-determined questions to determine the overall evaluation score, as well as to associate a different scoring weight with each of the plurality of pre-determined questions. The processor can also adjust the scoring weight associated with one or more questions based on data from the employee assessment unit and based on one or more evaluation parameters.

### BRIEF DESCRIPTION OF THE DRAWINGS

These and other features and advantages of the present invention will be more fully understood by reference to the following detailed description in conjunction with the attached drawings in which like reference numerals refer to like elements throughout the different views. The drawings illustrate principals of the invention and, although not to scale, show relative dimensions.

FIG. 1 is a schematic block diagram of an employee evaluation system according to the teachings of the present invention.

FIG. 2 is a schematic block diagram of the details of the employee assessment unit of FIG. 1 according to the teachings of the present invention.

FIG. 3A is flowchart diagram illustrating the method of performing an evaluation of an employee according to the teachings of the present invention.

FIG. 3B is flowchart diagram illustrating the method of adjusting weighted values associated with the sub-domains or questions of the employee evaluation system according to the teachings of the present invention.

FIG. 4 is a screen shot depicting information that can be displayed via a window and pane element on a computing system and that is associated with the list of system administrators registered with the employee evaluation system of the present invention.

FIG. 5 is a screen shot depicting the information associated with the clients registered with the employee evaluation system of the present invention.

FIGS. 6A-6C are screen shots depicting the domain information that can be displayed when a user performs an valuation of an employee according to the teachings of the present invention.

FIG. 7 is a screen shot depicting the various information that can be displayed on the dashboard of the employee evaluation system of the present invention.

FIG. 8 is a screen shot depicting the client information that can be displayed when a user selects the employee button element from the window according to the teachings of the present invention.

FIG. 9 is a schematic block diagram depicting an embodiment of a network environment comprising client devices in communication with servers through a network arrangement.

FIG. 10 is a schematic block diagram depicting a cloud computing environment that includes client devices in communication with a cloud service provider.

FIGS. 11 and 12 are schematic block diagrams depicting embodiments of computing devices useful for the methods and systems described herein.

### DETAILED DESCRIPTION

It is increasingly important in today's ever shifting marketplace to be able to timely and accurately evaluate, assess and determine the value of a person or employee to a company or organization. As used herein, the term “company” is intended to refer to any organization of any size that requires or is beneficial that the job performance of an employee be evaluated. Examples of a company include an association, organization, business, joint partnership, partnership, joint venture, proprietorship and the like. The present invention helps identify the talent landscape of the company and provides fast, accurate and visual clarity of the employee's performance and value to the company. The system and method of the present invention assists the company in understanding the importance of having the correct people on your team and keeping the correct people in the company.

The system and method of the present invention is an on-line digital platform and/or mobile application that can be available on both IOS and Android platforms that gives managers of the company fast, easy and accurate clarity on the talent landscape of their company and any associated teams. The system of the present invention can be used as a stand-alone system or can be integrated or be adapted to communicate through an application program interface (API) with other systems and software, such as for example conventional payroll services and conventional human resource platforms, such as management training programs, talent development platforms, and annual evaluation and review programs.

The employee evaluation system of the present invention can help transform how leaders and managers of the company evaluate and interact with employees. The present invention can determine and provide leaders and managers real time, accurate insight and clarity into specific employees and teams and can employ data science and artificial intelligence to recognize employee patterns and predict outcomes. Further, the employee evaluation system of the present invention can determine the most effective actions leaders and managers should consider with employees.

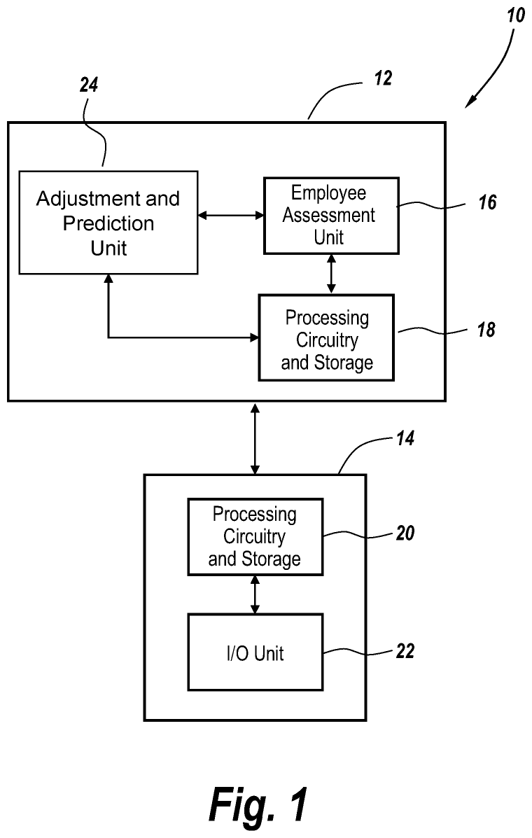

As shown in FIG. 1, the employee evaluation system 10 of the present invention can include a host server or device 12 that communicates with a client electronic device 14. The electronic device can be a computer, a smartphone, a laptop, a tablet, or any other device suitable for connecting to and communicating with the server 14. The illustrated server 14 includes a personnel or employee assessment unit 16 for receiving data from the client electronic device 14 and generating an overall work assessment or evaluation of an employee, and an adjustment and prediction unit 24 for adjusting selected parameters or variables of the employee assessment unit 16 and for predicting an evaluation score of an employee based on historical data provided by the employee assessment unit 16. The processing circuitry and corresponding storage 18 can be used to store the information provided to the server 12 from the client 14, as well as process or generate for storage the evaluation of the employee that is generated by the server 12.

The client electronic device 14 can include an input-output unit 22 for allowing a user to input selected data into the system 10. The client electronic device also includes processing circuitry and storage 20 for performing necessary processing tasks and storing selected data in the client electronic device 14.

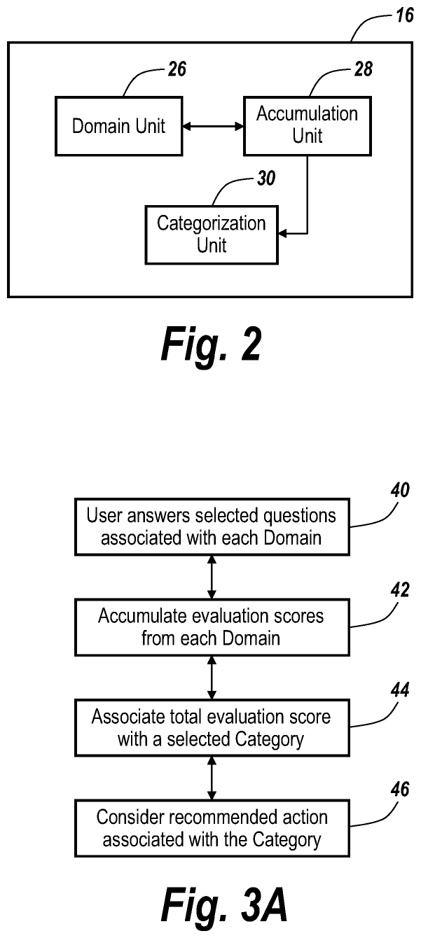

The employee assessment unit 16 is illustrated in further detail in FIG. 2. The employee assessment unit 16 is configured to assess or evaluate the performance of one or more employees of an organization, as well as quantify the value or importance of the employee to the organization. The employee assessment unit 16 includes a domain unit 26, an accumulation unit 28 and a categorization unit 30. The domain unit 26 provides multiple different domains with corresponding data that requires input via the I/O unit 22 of the client electronic device 14. According to one embodiment, the domains provided by the domain unit include a Performance domain, an Attitude domain, a Maintenance domain, and optional Compensation and/or Replacement domains. The domains are specific to particular types of evaluation related information that the system 10 uses when determining an evaluation score of an employee. For example, the Performance domain provides the user with questions directed to the employee's performance or work related output, quality of work product, ability to meet key performance indicators (KPIs), efficiency of work, and/or a qualitative assessment of the employee's impact on the company. The Attitude domain provides the user with questions directed to the behavioral aspects of the employee, including the coachability of the employee, work related attitude towards fellow employees, resilience during challenging times, cheerfulness and optimism, and overall engagement with work. The Maintenance domain provides the system user with questions directed to the ease of management of the employee, brand impact on the organization, and compensation level. Other domains can include for example Compensation and Replaceability domains that would have associated therewith one or more questions. Those of ordinary skill in the art will readily recognize that any combination of the foregoing domains can be used, or additional domains can also be used.

Moreover, each of the foregoing domains can have one or more sub-domains, and the sub-domains can include one or more predetermined and preselected questions seeking input from the system user. The system user can be, for example, a manager, leader, team leader, group leader, director, teacher, coach, human resource director, administrator, or supervisor of the employee. For the sake of simplicity, the term “manager” is employed throughout, although it is to be understood that the term encompasses the foregoing people and positions. Also for the sake of simplicity the term “employee” is used throughout and is intended to include any type of person employed by a company to perform work for wages, salary, a fee, or some other type of remuneration. Further, each question associated with each of the domains and/or sub-domains can have different relative scoring weights associated therewith. The system user answers each question (e.g., each sub-domain) associated with each of the domains, and optionally an evaluation score can be determined by the accumulation unit 28 and/or the processing circuitry 18 for each question or sub-domain, and for each specific domain. The evaluation score can be created for each of the domains in the domain unit 26. The accumulation unit 28 can accumulate the evaluation scores for each sub-domain and/or optionally for each domain and can optionally create a total evaluation score that is the sum of the evaluation scores for each sub-domain and/or each domain, and which is in essence the sum of the evaluation scores for each of the questions. In addition to the scores being weighted differently, if desired, the domains can be weighted differently relative to each other.

The categorization unit 30 receives the evaluation scores and preferably receives the total evaluation score from the accumulation unit 28 and associates one or more categories with the received evaluation score. The categories can be any selected series of categories, each of which has associated therewith a defined evaluation scoring range and is indicative of a relative value of the employee. Based on the value of the employee, the employee evaluation system 10 of the present invention can recommend to the user one or more actions to consider that involve the employee. By way of example, the categories can include any selected number of categories and can be labeled as needed. Each category is associated with a selected evaluation score or evaluation scoring range. The categories allow the system user (e.g., manager) to quickly evaluate or assess the performance and relative value of the employee to the organization in real time and when needed. The categories of the categorization unit 30 can include, for example, an Elevate or In-Play category for an employee with an evaluation score in the top (first) scoring range; an Appreciate or A-player category for the employee with an overall evaluation score in the next scoring range (second) below the Elevate category; a Motivate or B-player category for the employee with an evaluation score in the next scoring range (third) below the Elevate category; an Educate or C-player category for the employee with an overall evaluation score in the next scoring range (fourth) below the Motivate category; and an Eliminate or Replacement category for the employee with an evaluation score in the next scoring range (fifth) below the Educate category.

The employee evaluation system 10 of the present invention can allow the user to evaluate, assess and understand an employee's performance and value to the company in real time and as frequently as needed or desired. With the predefined scoring methodology according to the teachings of the present invention, managers can quickly and accurately assess and evaluate the performance and/or value of each employee to the company. This information allows the company to better understand and value the employees. This can include, for example, which employee is at risk of leaving the organization, which employee needs further attention and development, which employee needs to be motivated to perform better, which employee is valuable and ready for a promotion, and which employee needs to be placed on a performance improvement plan and/or who needs to be replaced altogether. With this information, managers can act swiftly and confidently rather than waiting until the end of the year review process associated with conventional systems.

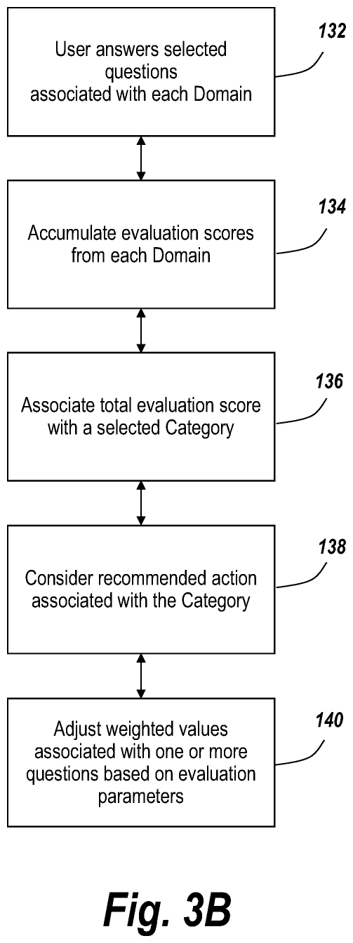

FIG. 3A is a flow chart illustrating the steps involved when evaluating an employee using the employee evaluation system 10 of the present invention. The employee evaluation system 10 allows a user, such as a manager, to access the system 10 and to perform the evaluation of the employee. The system 10 can, if desired, pre-load the employee's employment information into the system 10. The employee evaluation system 10 of the present invention uses a software and hardware based assessment tool to assess key components of an employee's value to the company.

The system user, such as the manager, communicates with the employee assessment unit 16 via the client electronic device 14. The assessment unit 16 includes a domain unit 26 that has associated therewith a plurality of domains, and each domain has a series of pre-defined questions associated therewith. The manager provides input data or answers associated with each question, step 40. The questions can have different scoring or weighted values associated therewith. The accumulation unit 16 can accumulate the evaluation scores of the employee for each domain and/or sub-domain. The accumulation unit 16 can then determine or calculate an overall evaluation score, which can be the sum of the scores of each question and/or of each domain, step 42. The total evaluation score is processed by the categorization unit 30 and the score is associated with a corresponding category, step 44. The category can have associated therewith actions that can be recommended to the manager based on the employee's evaluation score and associated category, step 46. For example, the Elevate category can be indicative of an employee that is an exceptional performer. As such, it is a high priority for the company to retain this employee by rewarding the employee in some manner, such as for example by recommending the employee for a raise or for a promotion. This category can also optionally signify that based on the performance and talent of the employee, the organization can be at risk of losing the employee to other organizations. The Appreciate category can signify that the employee is a strong or important member of the organization that has, for example, scored relatively highly on competence and character portions of the questions that form part of the domains. This type of employee can provide the company with a competitive advantage relative to competitors, and are potentially future leaders of the company. The category can also optionally signify that the organization take selected actions to show the employee that they are valued and appreciated. The Motivate category can be indicative of a reasonably good member of the company that gives the company a competitive advantage over much of the competition. This category of employee delivers consistent results and is a good team member with good behavioral competencies. The category can also optionally signify that the employee be recommended for professional development opportunities in order to increase the overall skill set of the employee. The Educate category can be indicative of an average employee relative to peers that still has a useful role in the company. The category can also optionally signify that the employee needs improvement and can be placed on a performance improvement plan. The Eliminate category is indicative of a below average employee relative to peers and provides the company with a competitive disadvantage and diminishes the organization's overall brand strength. The category can also optionally signify that the employee should be replaced.

The present invention also focuses the performance management topic to the most prevalent organizational opportunities by leveraging data science over a large-scale data asset. The employee evaluation system empowers the next generation manager by providing actionable guidance to drive performance improvements while leveraging artificial intelligence to recognize employee patterns and development opportunities for both the manager and the employee.

The server 16 can employ a data science engine, which can form part of the processing circuitry and storage unit 18, that relies on the signal collection of all entities involved in the performance development process, i.e. industry, company, department, manager, employee, assessment, and the like. A series of engineered data features can be generated, analyzed and monitored. These influence the performance of and maturation of the system 10 of the present invention, which is focused on bringing precision and recall accuracy to the predictive capabilities surrounding future performance, developmental areas, industry differentials and company employee and culture health projections.

FIG. 3B is flowchart diagram illustrating the method of adjusting weighted values associated with the sub-domains or questions of the employee evaluation system according to the teachings of the present invention. As noted above, the employee evaluation system allows the manager to input data or answers associated with each question or sub-domain, step 132. The questions can have different scoring or weighted values associated therewith, which can be adjusted by the adjustment and prediction unit 24 based on historical evaluation data or other selected parameters. For example, the adjustment and prediction unit 24 can analyze the evaluation data generated by the employee assessment unit 16 and adjust selected evaluations parameters associated therewith, including for example the weighted values associated with one or more questions. The evaluation parameters can be associated with historical evaluation data of one or more selected employees and company related or specific data, including for example the date of the last assessment or evaluation of the employee, the employment tenure of duration of the employee, the specific manager associated with the employee, the employment tenure or duration of the manager, the selected domain and/or sub-domain, the selected question, the selected answer to the question, the default or baseline weighted value associated with the question, and the selected department within the company. The adjustment and prediction unit 24 adjusts the weighted values, if necessary, of one or more questions based on these selected parameters. By adjusting the weighted values associated with each question based on the evaluation parameters, the employee evaluation system can generate an overall employee evaluation with higher fidelity and relevance while concomitantly properly identifying the value of the employee to the company.

The accumulation unit 16 then accumulates the evaluation scores of the employee for each domain and/or sub-domain. The accumulation unit 16 can then determine or calculate an overall evaluation score, which can be the sum of the scores of each question and/or of each domain, step 134. The total evaluation score is then processed by the categorization unit 30 and the total evaluation score is associated or compared with a corresponding category, step 136. Specifically, the employee evaluation system can associate or compare the total evaluation score with one or more of the Educate category, Motivate category, Appreciate category, and Elevate category. The category having an evaluation score or range that most closely matches the total evaluation score of the employee can be selected by the system. The category can have associated therewith actions that can be recommended to the manager based on the employee's evaluation score and associated category, step 138. The adjustment and prediction unit 24 can then adjust if necessary the weighted values associated with one or more questions of the domains and/or sub-domains based on the evaluation parameters, step 140. Based on the historical data generated over time by the employee assessment unit 16, the employee evaluation system can better predict the total evaluation score of the employee prior to the full assessment of evaluation being performed by the system. The adjustment and prediction unit 24 can employ one or more known classification or modeling algorithms to assist with determining the proper adjustments to be made to the weighted values of the questions as well as predicting an evaluation score of the employee, including for example statistical regression techniques, nearest neighbor classification techniques, support vector classifier (SVC) techniques, random forest techniques, and the like.

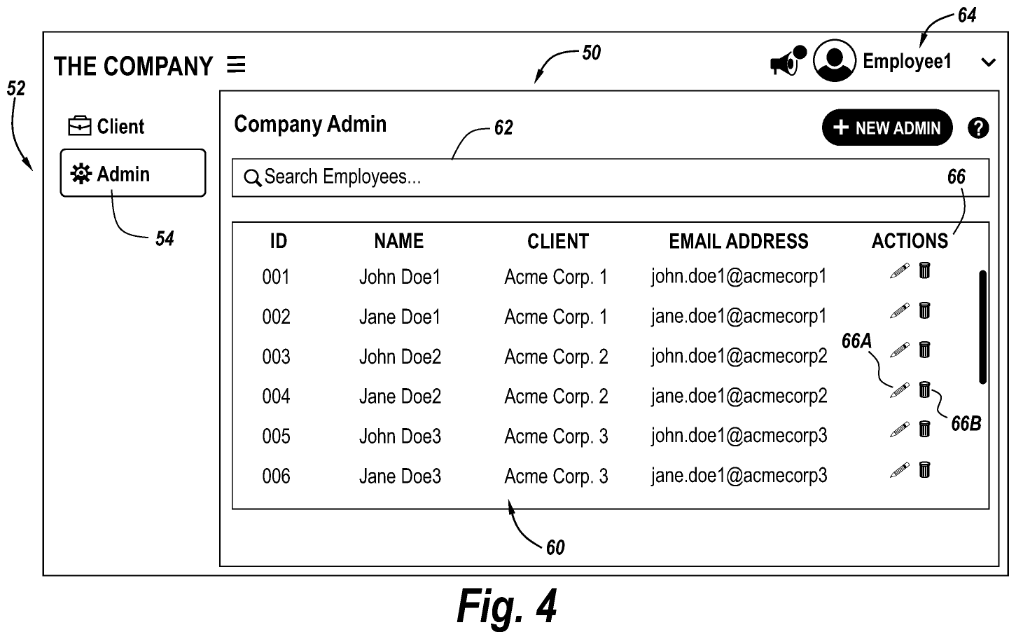

FIGS. 4 through 8 depict exemplary user interfaces implemented by the employee evaluation system 10 of the present invention. The interfaces can be displayed for example by the display device 546 of the computing device 600, which includes for example the client devices 14, 512. A system user can access the employee evaluation system 10 that is stored for example in memory 18, 532, 538, 564 of the computing device and implemented via the servers 12, 516 using a client device 14, 512.

FIG. 4 illustrates a screen shot showing an initial window 50 (herein generally referred to as a window, a frame or a page). The illustrated window and associated data is displayed on a suitable display device, such as the display 546, and the specific content in the window is dependent on the priority rights assigned to the specific user. If a user with relatively high priority rights accesses the system, then the window 50 is displayed with the frame content as shown. The identity of the user is displayed in the window ID element 64. In the window 50, along a left side thereof and located along a top portion thereof is a list of button elements 52 that are indicative of different windows and associated data that can be accessed by the user. For example, when the Admin button element 54 is selected or actuated by the user, the window 50 displays the organization or company administration page. The window 50 can include a centrally located frame or pane element 60. The pane element 60 can list one or more, and preferably all, of the administrators that have access to the employee evaluation system 10. The window lists the administrator name, the organization associated with the administrator, contact information such as an e-mail address, and selected action buttons 66. Those of ordinary skill in the art will readily recognize that the frame element 60 can display different types of information and the information can be displayed, organized or formatted in any selected manner. The illustrated action buttons 66 can include an edit button 66A and a delete button 66B. The edit button 66A allows the user to edit the information associated with one or more administrators in the list, and the delete button 66B allows the system user to delete a selected administrator from the list. A search box 62 can also be formed in the window 50 to allow the user to search for a specific administrator in the system 10. The identification information associated with the administrator that is using the system can be displayed in the window 50, such as in the static window element 64.

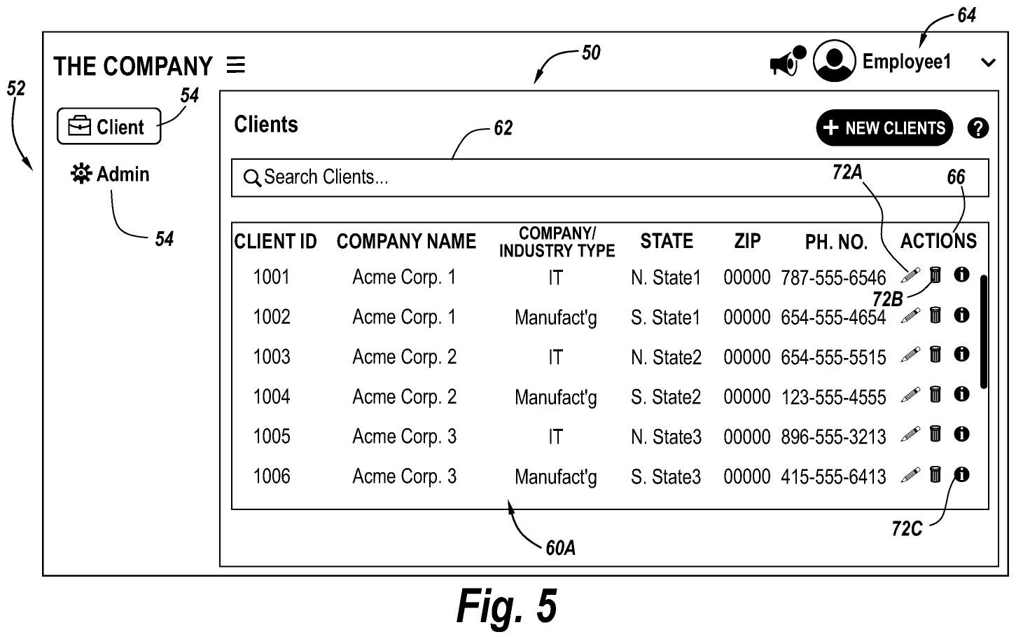

As shown in FIG. 5, when the Client button element 46 is selected or actuated by the user, then the window 50 displays different information. The pane element 60A can display client related or specific information, including for example a list of clients, and other related data. The data and client listing format can be customized to provide the information that is important to the anticipated users within the organization. For example, as displayed, the pane element 60 can include the client ID, company name and location particulars, and selected action buttons 72. The illustrated action buttons 72 can include an edit button 72A and a delete button 72B. The edit button 72A allows the user to edit the information associated with one or more clients in the list, and the delete button 72B allows the system user to delete a selected client from the list. An information button 72C can also be employed to allow the user to access specific information or functions of the employee evaluation system 10. A search box 62 can also be formed in the window 50 to allow the user to search for a specific client in the system 10.

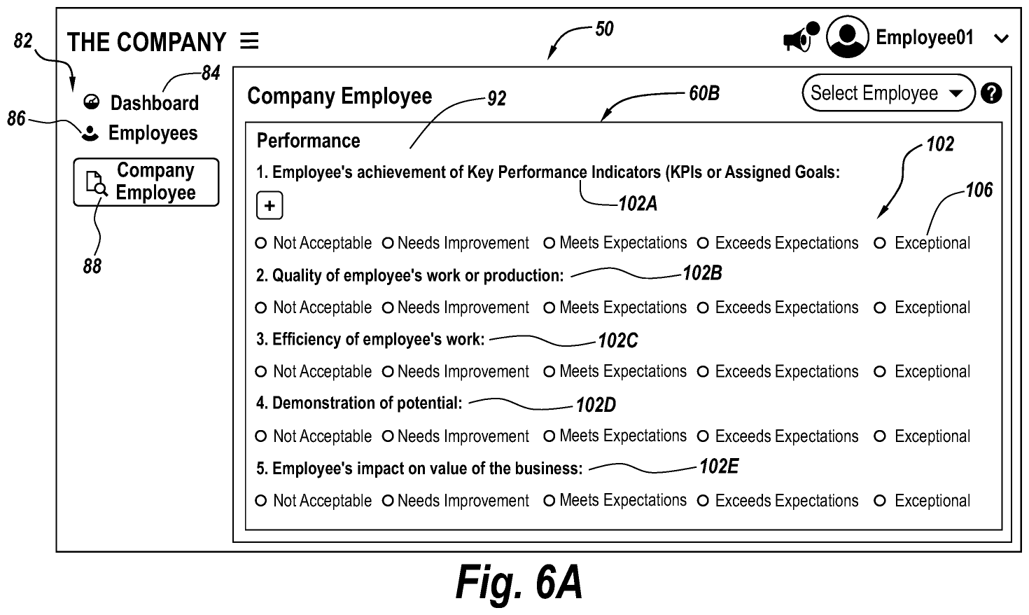

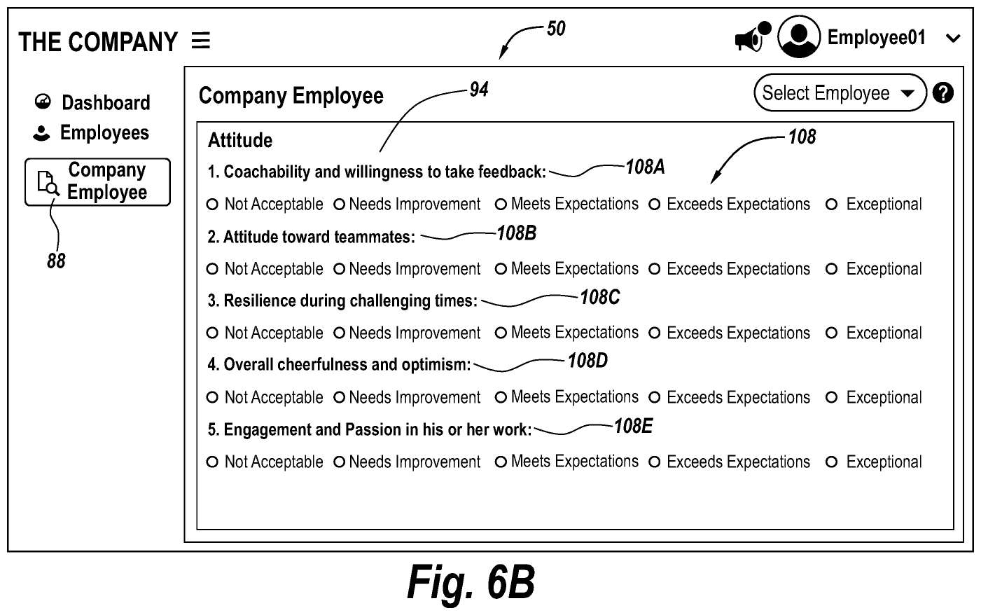

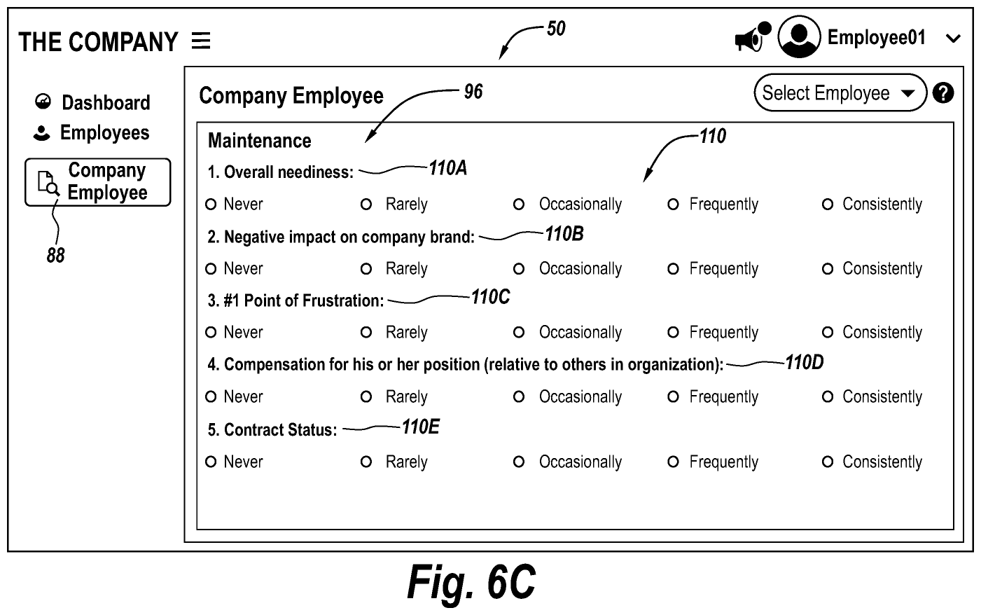

FIGS. 6A-6C illustrate interfaces or screen shots of the employee evaluation system 10 of the present invention when a user wishes to perform or initiate an evaluation or assessment of an employee. The window 50 can be displayed by clicking on the information button element 72C. As shown, the window 50 now displays a series of button elements 82 that includes a Dashboard button element 84 for displaying selected information in a dashboard style format, an Employee button element 86 for displaying information associated with one or more selected employees, and an Evaluation button element 88 for allowing an authorized user to perform an evaluation of a selected employee. When the Evaluation button element 88 is selected or actuated, the pane element 60B displays a set of information that allows the authorized user, such as a manager, to perform an evaluation of an employee. The pane element 60B displays the various domains, such as by employing the domain unit 26, and can include the Performance domain 92, the Attitude domain 94, and the Maintenance domain 96. The illustrated domains can also include a series or plurality of sub-domains. For example, the sub-domains of the present invention can include one or more pre-stored and pre-determined questions. As shown in FIG. 6A, the Performance domain 92 includes a series of sub-domains 102, including the sub-domains 102A-102E. Each of the questions or sub-domains 102A-102E can include a series of answer option elements 106 that allow the user to enter evaluation data into the system by answering the question. Each of the questions or sub-domains 102A-102E can have different scoring weights associated therewith, such that for example the sub-domain 102A has an evaluation score and/or weight that is different than 102B, which can be different than sub-domain 102C, and so forth. Similarly, as shown in FIG. 6B, which can be a different pane element or can be a continuation of the pane element 60B, the Attitude domain is displayed. Similar to the Performance domain 92, the Attitude domain 94 can have a series of questions or sub-domains 108 associated therewith, including the sub-domains or questions 108A-108E. Each of the questions or sub-domains 108A-108E can have different scoring weights associated therewith, such that for example the sub-domain 108A has an evaluation score that is different than 108B, which can be different than sub-domain 108C, and so forth. Likewise, as shown in FIG. 6C, which can be a different pane element or can be a continuation of the pane element 60B, the Maintenance domain is displayed. Similar to the Performance domain 92 and the Attitude domain 94, the Maintenance domain 96 can have a series of questions or sub-domains 110 associated therewith, including the sub-domains or questions 110A-110E. Each of the questions or sub-domains 110A-110E can have different scoring weights associated therewith, such that for example the sub-domain 110A has an evaluation score and/or weight that is different than 110B, which can be different than sub-domain 110C, and so forth.

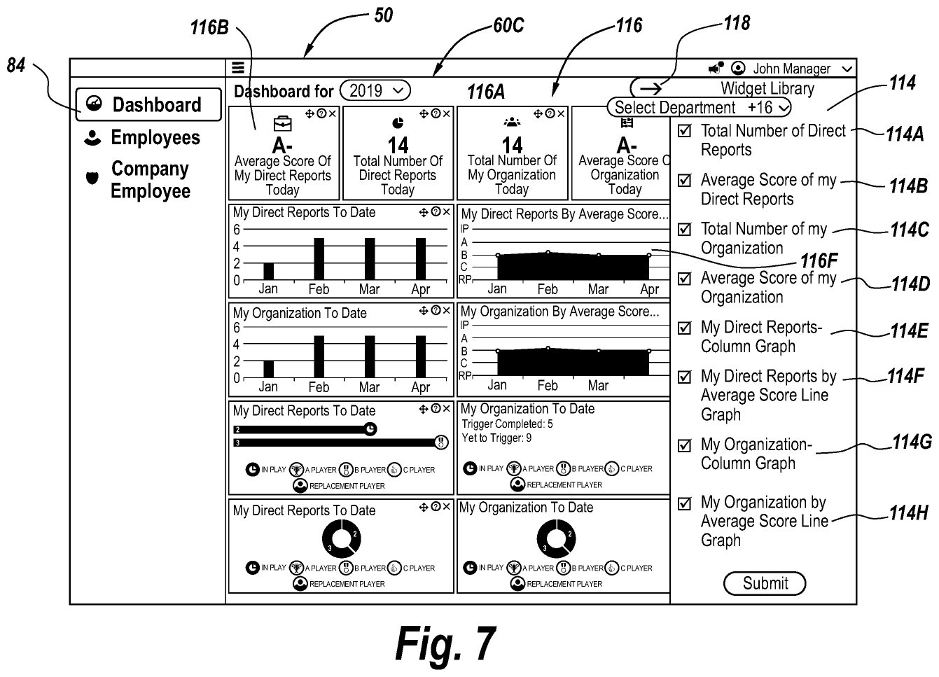

FIG. 7 illustrates the window 50 when the dashboard element 84 is selected or actuated by the user. The window 50 includes a pane element 60C that displays selected information to the user, and also includes a collapsible menu element 114. The menu element 114 can include a series of menu selections or options 114A-114H that correspond to different types or display options or manners of displaying and collating data from the employee evaluation system 10. When selected, the employee evaluation system generates a series of reports 116 that are displayed in the pane element 60C. For example, menu option 114A when selected displays in the pane element 60C a numerical representation of the number of employees directly reporting to a specific manager. As such, a corresponding report is generated by the system 10 and displayed, such as for example report 116A. Further, when the menu option 114B is selected, the employee evaluation system generates and displays a report indicating the average evaluation score of the employees directly reporting to the selected manager or system user. As such, a corresponding report is generated by the system 10 and displayed, such as for example report 116B. When the menu option 114F is selected, the employee evaluation system generates and displays report 116F. The menu options 114A-114H and reports 116 allow the manager to populate the pane element 60C with selected data in different report styles and formats. The system 10 generates and displays a report for each menu option that is selected. This enables the manager to view employees and corresponding data in a manner that is easily viewable by the manager based on personal preferences. The menu element 114 is collapsible, that is, can disappear, by actuating the arrow element 118. Those of ordinary skill in the art will readily recognize that the number and types of menu options 114 and reports 116 can vary. The menu options 114A-H are intended to be examples of the various types of options that can be employed by the system 10.

The dashboard element 84 and corresponding reports 116 can assist the manager in quickly and easily identifying which employees are at risk of leaving and the employees in need of development and improvement. Equipped with this knowledge, managers have the opportunity to manage in the moment using proactive versus reactive management strategies by addressing performance problems as they occur and increasing engagement with top performers to ensure retention.

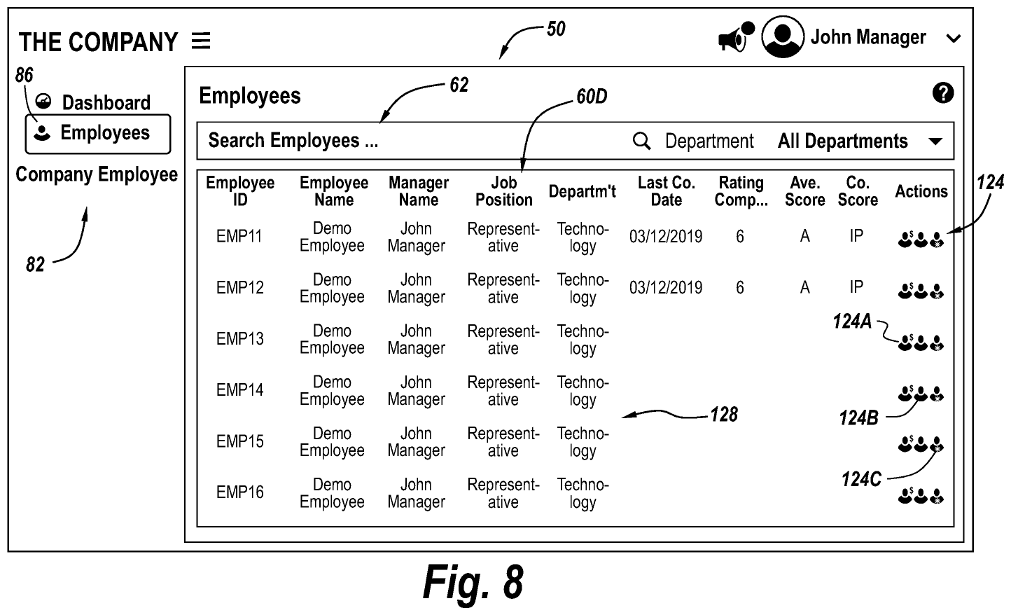

FIG. 8 illustrates the window 50 when the employee element 86 is selected or actuated by the user. The window includes a search box 62 and a pane element 60D that displays employee information 128 associated with a selected company. The illustrated employee information 128 can include, by way of example, the employee name and company identification, position, and department. The employee information can also include the date of the last employee evaluation, the number of completed ratings, and the average evaluation score. Those of ordinary skill in the art will readily recognize that the pane element 60D and the employee evaluation system 10 of the present invention can display any selected combination of employee information 128. The pane element 60D further includes a series of action buttons 124, including for example action buttons 124A, 124B and 124C.

As will be appreciated by one of ordinary skill in the art, various aspects of the preferred embodiments may be operated in an entirely software embodiment in any suitable programming language, in an entirely hardware embodiment, or in a combination thereof. The suitable programming language can be executed on any suitable electronic device, such as on the client devices or the servers described herein. Further, the present invention can take the form of a computer program product that is stored on a non-transitory computer readable medium and is executed by a suitable instruction execution system or processor in the electronic device. The term non-transitory computer readable medium, as used herein, refers to any medium that participates in providing instructions to one or more processors for execution that are not transitory in nature. Such a medium may take many forms, including but not limited to non-volatile media, volatile media, and transmission media. Non-volatile media includes, for example, optical or magnetic disks, such as a storage device. Other types of non-volatile media can include non-volatile read access memory (NVRAM), flash memory non-volatile static RAM (nvSRAM), Ferroelectric RAM (FeRAM), Magnetoresistive RAM (MRAM), Phase-change memory (PRAM), conductive-bridging RAM (CBRAM), Silicon-Oxide-Nitride-Oxide-Silicon (SONOS), Resistive RAM (RRAM), Racetrack, Nano-RAM (NRAM), or Millipede memory. Volatile media includes dynamic memory, such as main memory or random access memory (RAM), dynamic random access memory (DRAM) or any known variants, such as static random access memory (SRAM), Burst SRAM or SynchBurst SRAM (BSRAM), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). Common forms of computer-readable media include, for example, a flexible disk, hard disk, magnetic tape, magnetic medium, a CD-ROM, memory elements such as RAM, PROM, EPROM, or FLASH-EPROM, optical medium, or any other physical medium which a computer can read.

It is understood that the description contained herein is considered as illustrative only of the various aspects of the preferred embodiments. Further, since numerous modifications and changes will readily occur to those skilled in the art, it is not desired to limit the present invention to the construction and operation shown and described, and accordingly, all suitable modifications and equivalents may be resorted to.

Following below and referenced above are more detailed descriptions of various concepts related to, and embodiments of, the employee evaluation system 10 of the present invention. The employee evaluation system is a system for evaluating the job performance of an employee employing the foregoing scoring system, and the initiating a selected action based on the evaluation score. It should be appreciated that various concepts introduced above and discussed in greater detail below may be implemented in any number of ways, as the disclosed concepts are not limited to any particular manner of implementation. Examples of specific implementations and applications are provided below primarily for illustrative purposes and for providing or describing the operating environment of the alternative trading system of the present invention.

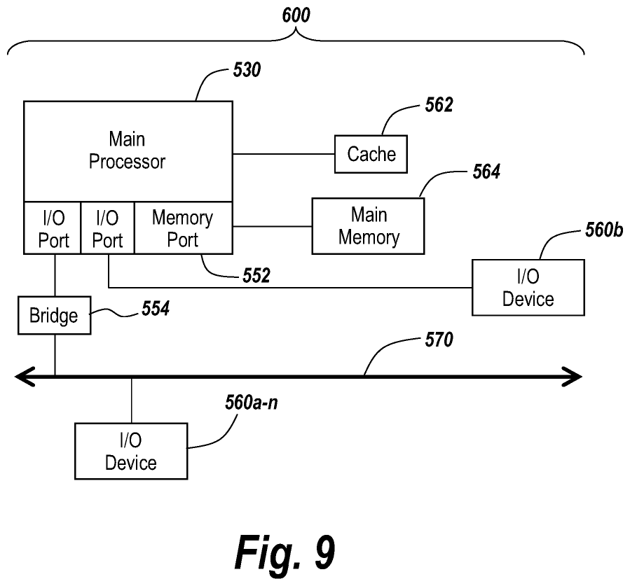

Consistent with the foregoing inventive embodiments, it is helpful to describe aspects of the operating environment as well as associated system components (e.g., hardware elements) in connection with the methods and systems described herein. Referring to FIG. 9, an embodiment of a network environment is depicted. In brief overview, the illustrated exploring network environment includes one or more clients 512a-512n (also generally referred to as local machine(s) 512, client(s) 512, client node(s) 512, client machine(s) 512, client computer(s) 512, client device(s) 512, endpoint(s) 512, or endpoint node(s) 512) in communication with one or more servers 516a-516n (also generally referred to as server(s) 516, node 516, or remote machine(s) 516) via one or more networks 514. In some embodiments, a client 512 has the capacity to function as both a client node seeking access to resources provided by a server and as a server providing access to hosted resources for other clients 512a-512n. The clients can be any suitable electronic or computing device, including for example, a computer, a server, a smartphone, a smart electronic pad, a portable computer, and the like, such as the computing device 600. The employee evaluation system of the present invention allows managers to access the system through the client devices, including the client device 14. One or more of the servers 516a-n in the server farm 518 can correspond to the server 14 of FIG. 1.

Although FIG. 9 shows a network 514 between the clients 512 and the servers 516, the clients 512 and the servers 516 may be on the same network 514. In some embodiments, there are multiple networks 514 between the clients 512 and the servers 516. In one of these embodiments, a network 514′ (not shown) may be a private network and a network 514 may be a public network. In another of these embodiments, a network 514 may be a private network and a network 514′ a public network. In still another of these embodiments, networks 514 and 514′ may both be private networks.

The network 514 may be connected via wired or wireless links. Wired links may include Digital Subscriber Line (DSL), coaxial cable lines, or optical fiber lines. The wireless links may include BLUETOOTH, Wi-Fi, NFC, RFID Worldwide Interoperability for Microwave Access (WiMAX), an infrared channel or satellite band. The wireless links may also include any cellular network standards used to communicate among mobile devices, including standards that qualify as 1G, 2G, 3G, 4G, or 5G. The network standards may qualify as one or more generations of mobile telecommunication standards by fulfilling a specification or standards such as the specifications maintained by the International Telecommunication Union. The 3G standards, for example, may correspond to the International Mobile Telecommunications-2000 (IMT-2000) specification, and the 4G standards may correspond to the International Mobile Telecommunications Advanced (IMT-Advanced) specification. Examples of cellular network standards include AMPS, GSM, GPRS, UMTS, LTE, LTE Advanced, Mobile WiMAX, and WiMAX-Advanced. Cellular network standards may use various channel access methods e.g. FDMA, TDMA, CDMA, or SDMA. In some embodiments, different types of data may be transmitted via different links and standards. In other embodiments, the same types of data may be transmitted via different links and standards.

The network 514 may be any type and/or form of network. The geographical scope of the network 514 may vary widely and the network 514 can be a body area network (BAN), a personal area network (PAN), a local-area network (LAN), e.g. Intranet, a metropolitan area network (MAN), a wide area network (WAN), or the Internet. The topology of the network 514 may be of any form and may include, e.g., any of the following: point-to-point, bus, star, ring, mesh, or tree. The network 514 may be an overlay network, which is virtual and sits on top of one or more layers of other networks 514′. The network 514 may be of any such network topology as known to those ordinarily skilled in the art capable of supporting the operations described herein. The network 514 may utilize different techniques and layers or stacks of protocols, including, e.g., the Ethernet protocol, the internet protocol suite (TCP/IP), the ATM (Asynchronous Transfer Mode) technique, the SONET (Synchronous Optical Networking) protocol, or the SDH (Synchronous Digital Hierarchy) protocol. The TCP/IP internet protocol suite may include application layer, transport layer, internet layer (including, e.g., IPv6), or the link layer. The network 514 may be a type of a broadcast network, a telecommunications network, a data communication network, or a computer network.

In some embodiments, the network system may include multiple, logically-grouped servers 516. In one of these embodiments, the logical group of servers may be referred to as a server farm 518 or a machine farm 518. In another of these embodiments, the servers 516 may be geographically dispersed. In other embodiments, a machine farm 518 may be administered as a single entity. In still other embodiments, the machine farm 518 includes a plurality of machine farms 518. The servers 516 within each machine farm 518 can be heterogeneous, and one or more of the servers 516 or machines 516 can operate according to one type of operating system platform (e.g., WINDOWS NT, manufactured by Microsoft Corp. of Redmond, Wash.), while one or more of the other servers 516 can operate according to another type of operating system platform (e.g., Unix, Linux, or Mac OS X).

In one embodiment, servers 516 in the machine farm 518 may be stored in high-density rack systems, along with associated storage systems, and located in an enterprise data center. In this embodiment, consolidating the servers 516 in this way may improve system manageability, data security, the physical security of the system, and system performance by locating servers 516 and high performance storage systems on localized high performance networks. Centralizing the servers 516 and storage systems and coupling them with advanced system management tools allows more efficient use of server resources.

The servers 516 of each machine farm 518 do not need to be physically proximate to another server 516 in the same machine farm 518. Thus, the group of servers 516 logically grouped as a machine farm 518 may be interconnected using a wide-area network (WAN) connection or a metropolitan-area network (MAN) connection. For example, a machine farm 518 may include servers 516 physically located in different continents or different regions of a continent, country, state, city, campus, or room. Data transmission speeds between servers 516 in the machine farm 518 can be increased if the servers 516 are connected using a local-area network (LAN) connection or some form of direct connection. Additionally, a heterogeneous machine farm 518 may include one or more servers 516 operating according to a type of operating system, while one or more other servers 516 execute one or more types of hypervisors rather than operating systems. In these embodiments, hypervisors may be used to emulate virtual hardware, partition physical hardware, virtualized physical hardware, and execute virtual machines that provide access to computing environments, allowing multiple operating systems to run concurrently on a host computer. Native hypervisors may run directly on the host computer. Hypervisors may include VMware ESX/ESXi, manufactured by VMWare, Inc., of Palo Alto, Calif.; the Xen hypervisor, an open source product whose development is overseen by Citrix Systems, Inc.; the HYPER-V hypervisors provided by Microsoft or others. Hosted hypervisors may run within an operating system on a second software level. Examples of hosted hypervisors may include VMware Workstation and VIRTUALBOX.

Management of the machine farm 518 may be de-centralized. For example, one or more servers 516 may comprise components, subsystems and modules to support one or more management services for the machine farm 518. In one of these embodiments, one or more servers 516 provide functionality for management of dynamic data, including techniques for handling failover, data replication, and increasing the robustness of the machine farm 518. Each server 516 may communicate with a persistent store and, in some embodiments, with a dynamic store.

Server 516 may be a file server, application server, web server, proxy server, appliance, network appliance, gateway, gateway server, virtualization server, deployment server, SSL VPN server, or firewall, or any other suitable computing device, such as computing device 600. In one embodiment, the server 516 may be referred to as a remote machine or a node. In another embodiment, a plurality of nodes may be in the path between any two communicating servers. The employee evaluation system 10 of the present invention can be stored on one or more of the servers 16, and the hardware associated with the server, such as the processor or CPU 30 and 36 and memory 33, 38, and 64 can be employed.

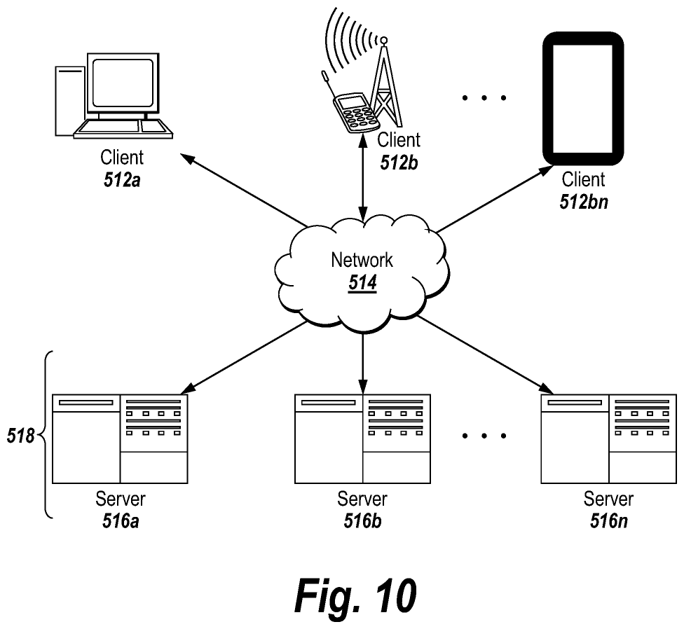

Referring to FIG. 10, a cloud computing environment is depicted for delivering for example software as a service (SaaS). According to one practice of the present invention, the employee evaluation system 10 can be implemented as a SaaS. A cloud computing environment may provide clients 14, 512 (illustrated as 512a-n) with one or more resources provided by a network environment. The cloud computing environment may include one or more clients 512a-512n, in communication with the cloud 520 over one or more networks, an illustrative example of which is network 514 employing one or more servers 12, 516. Clients 14, 512 may include in addition to normal or conventional clients, either thick clients, thin clients, and zero clients. A thick client may provide at least some functionality even when disconnected from the cloud 520 or servers 12, 516. A thin client or a zero client may depend on the connection to the cloud 520 or server 516 to provide functionality. A zero client may depend on the cloud 520 or other networks 514 or servers 12, 516 to retrieve operating system data for the client device. The cloud 520 may include back end platforms, e.g., servers 12, 516, storage, server farms or data centers.

The cloud 520 may be public, private, or a hybrid of both. Public clouds may include public servers 516 that are maintained by third parties to the clients 14, 512 or the owners of the clients. The servers 12, 516 may be located off-site in remote geographical locations as disclosed above or otherwise. Public clouds may be connected to the servers 516 over a public network. Private clouds may include private servers 516 that are physically maintained by clients 512 or owners of clients. Private clouds may be connected to the servers 516 over a private network 514. Hybrid clouds 520 may include both the private and public networks 514 and servers 516. The employee evaluation system 10 of the present invention can also be implemented in the cloud 20, and hence would be stored as software 522, and utilize the platform 524 and infrastructure 526 of the cloud 520, as well as one or more components of the computing device 600.

The cloud 520 including the employee evaluation system 10 of the present invention may also include a cloud based delivery, e.g. Software as a Service (SaaS) 22, Platform as a Service (PaaS) 24, and Infrastructure as a Service (IaaS) 26. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif. PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif. SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Clients 14, 512 may access IaaS resources with one or more IaaS standards, including, e.g., Amazon Elastic Compute Cloud (EC2), Open Cloud Computing Interface (OCCI), Cloud Infrastructure Management Interface (CIMI), or OpenStack standards. Some IaaS standards may allow clients access to resources over HTTP, and may use Representational State Transfer (REST) protocol or Simple Object Access Protocol (SOAP). Clients 512 may access PaaS resources with different PaaS interfaces. Some PaaS interfaces use HTTP packages, standard Java APIs, JavaMail API, Java Data Objects (JDO), Java Persistence API (JPA), Python APIs, web integration APIs for different programming languages including, e.g., Rack for Ruby, WSGI for Python, or PSGI for Perl, or other APIs that may be built on REST, HTTP, XML, or other protocols. Clients 512 may access SaaS resources through the use of web-based user interfaces, provided by a web browser (e.g. GOOGLE CHROME, Microsoft INTERNET EXPLORER, or Mozilla Firefox provided by Mozilla Foundation of Mountain View, Calif). Clients 512 may also access SaaS resources through smartphone or tablet applications, including, e.g., Salesforce Sales Cloud, or Google Drive app. Clients 512 may also access SaaS resources through the client operating system, including, e.g., Windows file system for DROPBOX.

In some embodiments, access to IaaS, PaaS, or SaaS resources may be authenticated. For example, a server or authentication server may authenticate a user via security certificates, HTTPS, or API keys. API keys may include various encryption standards such as, e.g., Advanced Encryption Standard (AES). Data resources may be sent over Transport Layer Security (TLS) or Secure Sockets Layer (SSL).

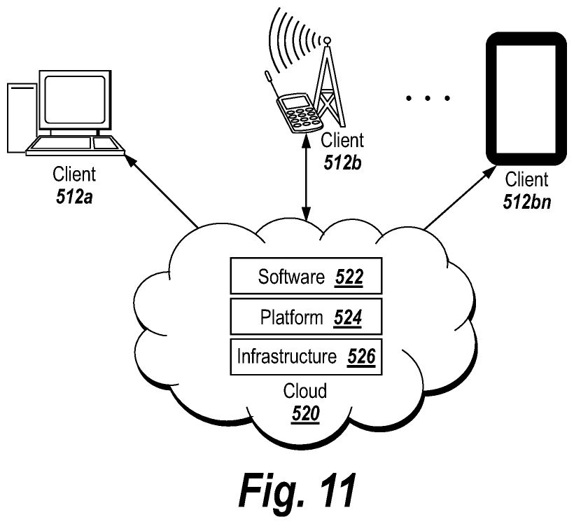

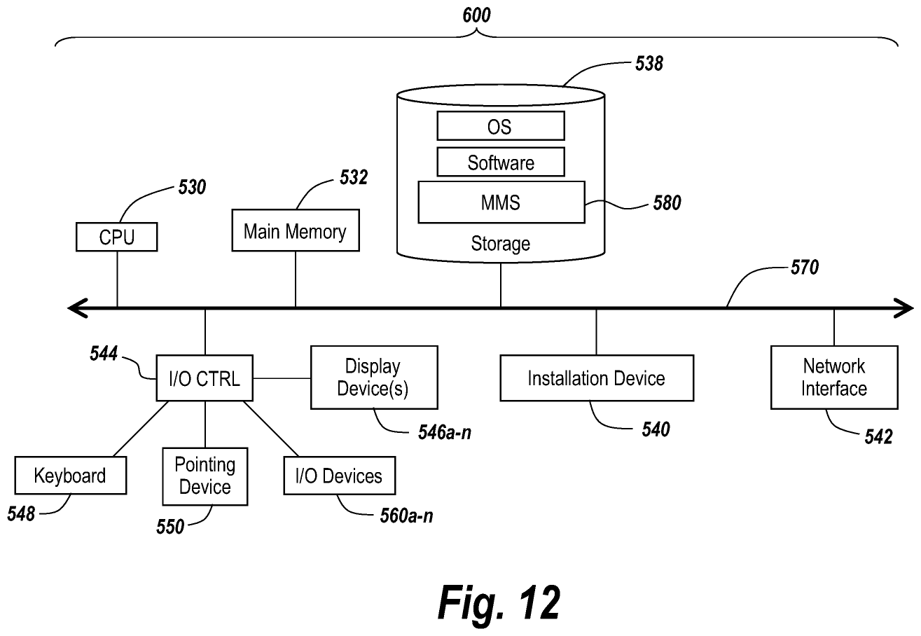

The client 14, 512 and server 12, 516 may be deployed as and/or executed on any type and form of computing device, such as for example a computer, network device or appliance capable of communicating on any type and form of network and performing the operations described herein. FIGS. 11 and 12 depict block diagrams of a computing device 600 useful for practicing an embodiment of the client 14, 512 and/or a server 12, 516. As shown in FIGS. 11 and 12, each computing device 600, which can correspond to the server 12 and/or the client device 14, includes a central processing unit 530 and a main memory unit 532. This hardware and associated functionality corresponds to the processing circuitry and storage units 18 and 20 of the employee evaluation system 10, FIG. 1. As shown in FIG. 11, a computing device 600 may include a storage device 538, an installation device 540, a network interface 542, an I/O controller 544 (including the I/O unit 22), display devices 546a-546n, a keyboard 548 and a pointing device 550, e.g. a mouse. The storage device 538 may include, without limitation, an operating system, and/or software of an employee evaluation system. As shown in FIG. 12, each computing device 600 may also include additional optional elements, e.g. a memory port 552, a bridge 554, one or more input/output devices 560a-560n (generally referred to using reference numeral 560), and a cache memory 562 in communication with the central processing unit 530.

The central processing unit 530 is any logic circuitry that responds to and processes instructions fetched from the main memory unit 564. In many embodiments, the central processing unit 530 is provided by a microprocessor unit, e.g.: those manufactured by Intel Corporation of Mountain View, Calif; those manufactured by Motorola Corporation of Schaumburg, Ill.; the ARM processor and TEGRA system on a chip (SoC) manufactured by Nvidia of Santa Clara, Calif; the POWER7 processor, those manufactured by International Business Machines of White Plains, N.Y.; or those manufactured by Advanced Micro Devices of Sunnyvale, Calif. The computing device 600 may be based on any of these processors, or any other processor capable of operating as described herein. The central processing unit 530 may utilize instruction level parallelism, thread level parallelism, different levels of cache, and multi-core processors. A multi-core processor may include two or more processing units on a single computing component. Examples of multi-core processors include the AMD PHENOM IIX2, INTEL CORE i5 and INTEL CORE i7.

Main memory unit 564 may include one or more memory chips capable of storing data and allowing any storage location to be directly accessed by the processor 530. The main memory unit 564 may be volatile and faster than memory of the storage unit 538. Main memory units 564 may be Dynamic random access memory (DRAM) or any variants, including static random access memory (SRAM), Burst SRAM or SynchBurst SRAM (BSRAIVI), Fast Page Mode DRAM (FPM DRAM), Enhanced DRAM (EDRAM), Extended Data Output RAM (EDO RAM), Extended Data Output DRAM (EDO DRAM), Burst Extended Data Output DRAM (BEDO DRAM), Single Data Rate Synchronous DRAM (SDR SDRAM), Double Data Rate SDRAM (DDR SDRAM), Direct Rambus DRAM (DRDRAM), or Extreme Data Rate DRAM (XDR DRAM). In some embodiments, the main memory 564 or the storage 538 may be non-volatile; e.g., non-volatile read access memory (NVRAM), flash memory non-volatile static RAM (nvSRAM), Ferroelectric RAM (FeRAM), Magnetoresistive RANI (MRANI), Phase-change memory (PRAM), conductive-bridging RAM (CBRAM), Silicon-Oxide-Nitride-Oxide-Silicon (SONOS), Resistive RAM (RRAM), Racetrack, Nano-RANI (NRAM), or Millipede memory. The main memory 564 may be based on any of the above described memory chips, or any other available memory chips capable of operating as described herein. In the embodiment shown in FIG. 11, the processor 530 communicates with main memory 532 via a system bus 570 (described in more detail below). FIG. 11 depicts an embodiment of a computing device 600 in which the processor communicates directly with main memory 564 via a memory port 552. For example, in FIG. 12 the main memory 564 may be DRDRAM.

FIG. 12 depicts an embodiment in which the main processor 530 communicates directly with cache memory 562 via a secondary bus, sometimes referred to as a backside bus. In other embodiments, the main processor 530 communicates with cache memory 562 using the system bus 570. Cache memory 562 typically has a faster response time than main memory 564 and is typically provided by SRAM, B SRAM, or EDRAM. In the embodiment shown in FIG. 12, the processor 530 communicates with various I/O devices 560 via a local system bus 570. Various buses may be used to connect the central processing unit 530 to any of the I/O devices 560, including a PCI bus, a PCI-X bus, or a PCI-Express bus, or a NuBus. For embodiments in which the I/O device is a video display 546, the processor 530 may use an Advanced Graphics Port (AGP) to communicate with the display 546 or the I/O controller 544 for the display 546. FIG. 12 depicts an embodiment of a computer 600 in which the main processor 530 communicates directly with I/O device 560b or other processors 530 via HYPERTRANSPORT, RAPIDIO, or INFINIBAND communications technology. FIG. 12 also depicts an embodiment in which local busses and direct communication are mixed: the processor 530 communicates with I/O device 560a using a local interconnect bus while communicating with I/O device 560b directly.

A wide variety of I/O devices 560a-560n may be present in the computing device 600. Input devices may include keyboards, mice, trackpads, trackballs, touchpads, touch mice, multi-touch touchpads and touch mice, microphones, multi-array microphones, drawing tablets, cameras, single-lens reflex camera (SLR), digital SLR (DSLR), CMOS sensors, accelerometers, infrared optical sensors, pressure sensors, magnetometer sensors, angular rate sensors, depth sensors, proximity sensors, ambient light sensors, gyroscopic sensors, or other sensors. Output devices may include video displays, graphical displays, speakers, headphones, inkjet printers, laser printers, and 3D printers.

Devices 560a-560n may include a combination of multiple input or output devices, including, e.g., Microsoft KINECT, Nintendo Wiimote for the WII, Nintendo WII U GAMEPAD, or Apple IPHONE. Some devices 560a-560n allow gesture recognition inputs through combining some of the inputs and outputs. Some devices 560a-560n provides for facial recognition which may be utilized as an input for different purposes including authentication and other commands. Some devices 560a-560n provides for voice recognition and inputs, including, e.g., Microsoft KINECT, SIRI for IPHONE by Apple, Google Now or Google Voice Search.

Additional devices 560a-560n have both input and output capabilities, including, e.g., haptic feedback devices, touchscreen displays, or multi-touch displays. Touchscreen, multi-touch displays, touchpads, touch mice, or other touch sensing devices may use different technologies to sense touch, including, e.g., capacitive, surface capacitive, projected capacitive touch (PCT), in-cell capacitive, resistive, infrared, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, e.g., pinch, spread, rotate, scroll, or other gestures. Some touchscreen devices, including, e.g., Microsoft PIXEL SENSE or Multi-Touch Collaboration Wall, may have larger surfaces, such as on a table-top or on a wall, and may also interact with other electronic devices. Some I/O devices 560a-560n, display devices 546a-546n or group of devices may be augment reality devices. The I/O devices may be controlled by an I/O controller 44 as shown in FIG. 11. The I/O controller may control one or more I/O devices, such as, e.g., a keyboard 548 and a pointing device 550, e.g., a mouse or optical pen. Furthermore, an I/O device may also provide storage and/or an installation medium 540 for the computing device 600. In still other embodiments, the computing device 600 may provide USB connections (not shown) to receive handheld USB storage devices. In further embodiments, an I/O device 560 may be a bridge between the system bus 570 and an external communication bus, e.g. a USB bus, a SCSI bus, a FireWire bus, an Ethernet bus, a Gigabit Ethernet bus, a Fibre Channel bus, or a Thunderbolt bus.

In some embodiments, display devices 546a-546n may be connected to I/O controller 544. Display devices may include, e.g., liquid crystal displays (LCD), thin film transistor LCD (TFT-LCD), blue phase LCD, electronic papers (e-ink) displays, flexile displays, light emitting diode displays (LED), digital light processing (DLP) displays, liquid crystal on silicon (LCOS) displays, organic light-emitting diode (OLED) displays, active-matrix organic light-emitting diode (AMOLED) displays, liquid crystal laser displays, time-multiplexed optical shutter (TMOS) displays, or 3D displays. Examples of 3D displays may use, e.g. stereoscopy, polarization filters, active shutters, or autostereoscopy. Display devices 546a-546n may also be a head-mounted display (HMD). In some embodiments, display devices 546a-546n or the corresponding I/O controllers 544 may be controlled through or have hardware support for OPENGL or DIRECTX API or other graphics libraries.

In some embodiments, the computing device 600 may include or connect to multiple display devices 546a-546n, which each may be of the same or different type and/or form. The display devices can be employed to display the screenshots of FIGS. 4-8 of the employee evaluation system 10, and can form part of either of the client 14, 512 and server 12, 516 of the invention. As such, any of the I/O devices and controller 12, 560a-560n, 544 may include any type and/or form of suitable hardware, software, or combination of hardware and software to support, enable or provide for the connection and use of multiple display devices 546a-546n by the computing device 600. For example, the computing device 600 may include any type and/or form of video adapter, video card, driver, and/or library to interface, communicate, connect or otherwise use the display devices 546a-546n. In one embodiment, a video adapter may include multiple connectors to interface to multiple display devices 546a-546n. In other embodiments, the computing device 600 may include multiple video adapters, with each video adapter connected to one or more of the display devices 546a-546n. In some embodiments, any portion of the operating system of the computing device 600 may be configured for using multiple displays 546a-546n. In other embodiments, one or more of the display devices 546a-546n may be provided by one or more other computing devices 600a or 600b connected to the computing device 600, via the network 514. In some embodiments software may be designed and constructed to use another computer's display device as a second display device 546a for the computing device 600. For example, in one embodiment, an Apple iPad may connect to a computing device 600 and use the display of the device 600 as an additional display screen that may be used as an extended desktop. One ordinarily skilled in the art will recognize and appreciate the various ways and embodiments that a computing device 600 may be configured to have multiple display devices 546a-546n.

Referring again to FIG. 11, the computing device 600 may comprise a storage device 538 (e.g. one or more hard disk drives or redundant arrays of independent disks) for storing an operating system or other related software, and for storing application software programs such as any program related to the software 580 for the employee evaluation system of the present invention. Examples of storage devices 538 include, e.g., hard disk drive (HDD); optical drive including CD drive, DVD drive, or BLU-RAY drive; solid-state drive (SSD); USB flash drive; or any other device suitable for storing data. Some storage devices may include multiple volatile and non-volatile memories, including, e.g., solid state hybrid drives that combine hard disks with solid state cache. The storage device 538 may be non-volatile, mutable, or read-only. The storage device 538 may be internal and connect to the computing device 600 via a bus 570. Further, the storage device 538 may be external and connect to the computing device 600 via an I/O device 560 that provides an external bus. Some storage devices 538 may connect to the computing device 600 via the network interface 542 over a network 514, including, e.g., the Remote Disk for MACBOOK AIR by Apple. Some client devices 512 may not require a non-volatile storage device 538 and may be thin clients or zero clients 512. The storage device 538 may also be used as an installation device 540, and may be suitable for installing software and programs. Additionally, the operating system and the software can be run from a bootable medium, for example, a bootable CD, e.g. KNOPPIX, a bootable CD for GNU/Linux that is available as a GNU/Linux distribution from knoppix.net.

The computing device 600 may also install software or application from an application distribution platform. Examples of application distribution platforms include the App Store for iOS provided by Apple, Inc., the Mac App Store provided by Apple, Inc., GOOGLE PLAY for Android OS provided by Google Inc., Chrome Webstore for CHROME OS provided by Google Inc., and Amazon Appstore for Android OS and KINDLE FIRE provided by Amazon.com, Inc. An application distribution platform may facilitate installation of software on a client device 512. An application distribution platform may include a repository of applications on a server 516 or a cloud 520, which the clients 512a-512n may access over a network 514. An application distribution platform may include application developed and provided by various developers. A user of a client device 512 may select, purchase and/or download an application via the application distribution platform.

Furthermore, the computing device 600 may include a network interface 542 to interface to the network 514 through a variety of connections including, but not limited to, standard telephone lines LAN or WAN links (e.g., 802.11, T1, T3, Gigabit Ethernet, Infiniband), broadband connections (e.g., ISDN, Frame Relay, ATM, Gigabit Ethernet, Ethernet-over-SONET, ADSL, VDSL, BPON, GPON, fiber optical including FiOS), wireless connections, or some combination of any or all of the above. Connections can be established using a variety of communication protocols (e.g., TCP/IP, Ethernet, ARCNET, SONET, SDH, Fiber Distributed Data Interface (FDDI), IEEE 802.11a/b/g/n/ac CDMA, GSM, WiMax and direct asynchronous connections). In one embodiment, the computing device 600 communicates with other computing devices 600′ via any type and/or form of gateway or tunneling protocol e.g. Secure Socket Layer (SSL) or Transport Layer Security (TLS), or the Citrix Gateway Protocol manufactured by Citrix Systems, Inc. of Ft. Lauderdale, Fla. The network interface 542 may comprise a built-in network adapter, network interface card, PCMCIA network card, EXPRESSCARD network card, card bus network adapter, wireless network adapter, USB network adapter, modem or any other device suitable for interfacing the computing device 600 to any type of network capable of communication and performing the operations described herein.

The computing device 600 of the sort depicted in FIGS. 10 and 11 may operate under the control of an operating system, which controls scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 2000, WINDOWS Server 2012, WINDOWS CE, WINDOWS Phone, WINDOWS XP, WINDOWS VISTA, and WINDOWS 7, WINDOWS RT, and WINDOWS 8 all of which are manufactured by Microsoft Corporation of Redmond, Wash.; MAC OS and iOS, manufactured by Apple, Inc. of Cupertino, Calif.; and Linux, a freely-available operating system, e.g. Linux Mint distribution (“distro”) or Ubuntu, distributed by Canonical Ltd. of London, United Kingdom; or Unix or other Unix-like derivative operating systems; and Android, designed by Google, of Mountain View, Calif, among others. Some operating systems, including, e.g., the CHROME OS by Google, may be used on zero clients or thin clients, including, e.g., CHROMEBOOK S.

The computer system 600 can be any workstation, telephone, desktop computer, laptop or notebook computer, netbook, ULTRABOOK, tablet, server, handheld computer, mobile telephone, smartphone or other portable telecommunications device, media playing device, a gaming system, mobile computing device, or any other type and/or form of computing, telecommunications or media device that is capable of communication. The computer system 600 has sufficient processor power and memory capacity to perform the operations described herein. In some embodiments, the computing device 600 may have different processors, operating systems, and input devices consistent with the device. The Samsung GALAXY smartphones, e.g., operate under the control of Android operating system developed by Google, Inc. GALAXY smartphones receive input via a touch interface.

In some embodiments, the computing device 600 is a gaming system. For example, the computer system 100 may comprise a PLAYSTATION 3, or PERSONAL PLAYSTATION PORTABLE (PSP), or a PLAYSTATION VITA device manufactured by the Sony Corporation of Tokyo, Japan, a NINTENDO DS, NINTENDO 3DS, NINTENDO WII, or a NINTENDO WII U device manufactured by Nintendo Co., Ltd., of Kyoto, Japan, an XBOX 360 device manufactured by the Microsoft Corporation of Redmond, Wash.

In some embodiments, the computing device 600 is a digital audio player such as the Apple IPOD, IPOD Touch, and IPOD NANO lines of devices, manufactured by Apple Computer of Cupertino, Calif. Some digital audio players may have other functionality, including, e.g., a gaming system or any functionality made available by an application from a digital application distribution platform. For example, the IPOD Touch may access the Apple App Store. In some embodiments, the computing device 600 is a portable media player or digital audio player supporting file formats including, but not limited to, MP3, WAV, M4A/AAC, WMA Protected AAC, AIFF, Audible audiobook, Apple Lossless audio file formats and .mov, .m4v, and .mp4 MPEG-4 (H.264/MPEG-4 AVC) video file formats.

In some embodiments, the computing device 600 is a tablet e.g. the IPAD line of devices by Apple; GALAXY TAB family of devices by Samsung; or KINDLE FIRE, by Amazon.com, Inc. of Seattle, Wash. In other embodiments, the computing device 600 is an eBook reader, e.g. the KINDLE family of devices by Amazon.com, or NOOK family of devices by Barnes & Noble, Inc. of New York City, N.Y.

In some embodiments, the computing device 600 includes a combination of devices, e.g. a smartphone combined with a digital audio player or portable media player. For example, one of these embodiments is a smartphone, e.g. the IPHONE family of smartphones manufactured by Apple, Inc.; a Samsung GALAXY family of smartphones manufactured by Samsung, Inc; or a Motorola DROID family of smartphones. In yet another embodiment, the computing device 600 is a laptop or desktop computer equipped with a web browser and a microphone and speaker system, e.g. a telephony headset. In these embodiments, the computing devices 600 are web-enabled and can receive and initiate phone calls. In some embodiments, a laptop or a desktop computer is also equipped with a webcam or other video capture device that enables video chat and video call. In some embodiments, the computing device 600 is a wearable mobile computing device including but not limited to Google Glass and Samsung Gear.

In some embodiments, the status of one or more machines 12, 14, 512, 516 in the network 514 is monitored, generally as part of network management. In one of these embodiments, the status of a machine may include an identification of load information (e.g., the number of processes on the machine, CPU and memory utilization), of port information (e.g., the number of available communication ports and the port addresses), or of session status (e.g., the duration and type of processes, and whether a process is active or idle). In another of these embodiments, this information may be identified by a plurality of metrics, and the plurality of metrics can be applied at least in part towards decisions in load distribution, network traffic management, and network failure recovery as well as any aspects of operations of the present solution described herein. Aspects of the operating environments and components described above will become apparent in the context of the alternative trading system disclosed herein.

The foregoing description may provide illustration and description of various embodiments of the invention, but is not intended to be exhaustive or to limit the invention to the precise form disclosed. Modifications and variations of the trading system of the present invention may be possible in light of the above teachings or may be acquired from practice of the invention. For example, while a series of acts has been described above, the order of the acts may be modified in other implementations consistent with the principles of the invention. Further, non-dependent acts may be performed in parallel.

In addition, one or more implementations consistent with principles of the invention may be implemented using one or more devices and/or configurations other than those illustrated in the Figures and described in the Specification without departing from the spirit of the invention. One or more devices and/or components may be added and/or removed from the implementations of the figures depending on specific deployments and/or applications. Also, one or more disclosed implementations may not be limited to a specific combination of hardware. Furthermore, certain portions of the invention may be implemented as logic that may perform one or more functions. This logic may include hardware, such as hardwired logic, an application-specific integrated circuit, a field programmable gate array, a microprocessor, software, or a combination of hardware and software.

No element, act, or instruction used in the description of the invention should be construed critical or essential to the invention unless explicitly described as such. Also, as used herein, the article “a” is intended to include one or more items. Where only one item is intended, the term “a single” or similar language is used. Further, the phrase “based on,” as used herein is intended to mean “based, at least in part, on” unless explicitly stated otherwise. In addition, the term “user”, as used herein, is intended to be broadly interpreted to include, for example, an electronic device (e.g., a workstation) or a user of an electronic device, unless otherwise stated.

Further, the invention can be employed using any combination of features or elements as described above, and are not limited to the current recited steps or features.

It is intended that the invention not be limited to the particular embodiments disclosed above, but that the invention will include any and all particular embodiments and equivalents falling within the scope of the following appended claims.

We claim

1. An employee evaluation system, comprising:
an employee assessment unit for allowing a user to input through an input device evaluation data of an employee and for determining an evaluation score associated with the employee based on the inputted evaluation data, wherein the employee assessment unit includes:
a domain unit for providing a plurality of domains, wherein each of the plurality of domains includes a plurality of sub-domains, wherein each of the sub-domains has at least one pre-determined question associated therewith such that each of the plurality of domains has a plurality of pre-determined questions associated therewith, and wherein each of the pre-determined questions has a selected scoring weight associated therewith, such that the domain unit determines via a processor an evaluation score associated with each of the pre-determined questions based on the evaluation data inputted by the user and the scoring weight associated with the question,
an accumulation unit for accumulating the evaluation scores generated by the domain unit to determine via the processor an overall evaluation score, and
a categorization unit for associating the overall evaluation score generated by the accumulation unit with one of a plurality of employee categories, wherein each of the plurality of employee categories has a selected action associated therewith, and
a client electronic device having the input device for allowing the user to input the evaluation data into the employee assessment unit, and a display unit for displaying at least the plurality of domains and the plurality of sub-domains.

2. The employee evaluation system of claim 1, wherein the scoring weight associated with each of the plurality of pre-determined questions is different between at least two of the plurality of pre-determined questions.

3. The employee evaluation system of claim 1, wherein a first one of the plurality of pre-determined questions has a first scoring weight associated therewith, and a second one of the plurality of pre-determined questions has a second scoring weight associated therewith, wherein the first scoring weight is different than the second scoring weight.

4. The employee evaluation system of claim 1, wherein the plurality of domains includes a Performance domain, an Attitude domain and a Maintenance domain.

5. The employee evaluation system of claim 1, wherein the plurality of domains includes:
a first domain having one or more questions associated with the work performance of the employee,
a second domain having one or more questions associated with behavioral aspects of the employee, and
a third domain having one or more questions associated with management aspects of the employee.

6. The employee evaluation system of claim 1, wherein the plurality of categories includes:
a first category directed to employees with the total evaluation score in a first scoring range,
a second category directed to employees with a total evaluation score in a second scoring range, where the first scoring range is greater than the second scoring range,
a third category directed to employees with a total evaluation score in a third scoring range, where the second scoring range is greater than the third scoring range,
a fourth category directed to employees with a total evaluation score in a fourth scoring range, where the third scoring range is greater than the fourth scoring range, and
a fifth category directed to employees with a total evaluation score in a fifth scoring range, where the fourth scoring range is greater than the fifth scoring range.

7. The employee evaluation system of claim 6, wherein the action associated with the first category includes promoting the employee or providing increased remuneration to the employee;
wherein the action associated with the second category includes notifying the employee of their relative value to a company, wherein the action associated with the third category includes recommending the employee for professional development activities; wherein the action associated with the fourth category includes generating a performance improvement plan for the employee; and wherein the action associated with the fifth category includes replacing the employee.

8. The employee evaluation system of claim 1, further comprising an adjustment and prediction unit for adjusting the scoring weight associated with one or more questions based on data from the employee assessment unit and based on one or more evaluation parameters.

9. A method, implemented by a computing device, comprising:
providing a plurality of domains, wherein each of the plurality of domains includes a plurality of sub-domains, wherein each of the plurality of sub-domains has at least one pre-determined question associated therewith such that each of the plurality of domains has a plurality of pre-determined questions associated therewith, and wherein each of the pre-determined questions has a selected scoring weight associated therewith,
allowing a user to input via an input device evaluation data of an employee in response to the plurality of pre-determined questions,
determining via a processor an evaluation score associated with each of the plurality of pre-determined questions based on the evaluation data inputted by the user and the scoring weight associated with each of the plurality of questions,
determining via the processor an overall evaluation score of the employee from the evaluation scores of the plurality of domains,
associating the overall evaluation score with one of a plurality of employee categories, wherein each of the plurality of employee categories has a selected action associated therewith, and
displaying via a display unit at least the plurality of domains and the plurality of sub-domains.

10. The method of claim 9, wherein determining an overall evaluation score of the employee from the evaluation scores of the plurality of domains comprises accumulating the evaluation scores associated with the plurality of pre-determined questions to determine the overall evaluation score.

11. The method of claim 10, wherein the scoring weight associated with each of the plurality of pre-determined questions is different between at least two of the plurality of pre-determined questions.

12. The method of claim 9, further comprising adjusting the scoring weight associated with one or more questions based on data from the employee assessment unit and based on one or more evaluation parameters.

13. A non-transitory storage medium storing instructions that cause a processor to:
provide a plurality of domains, wherein each of the plurality of domains includes a plurality of sub-domains, wherein each of the plurality of sub-domains has at least one pre-determined question associated therewith such that each of the plurality of domains has a plurality of pre-determined questions associated therewith, and wherein each of the pre-determined questions has a selected scoring weight associated therewith,
allow a user to input evaluation data of an employee in response to the plurality of pre-determined questions,
determine an evaluation score associated with each of the plurality of pre-determined questions based on the evaluation data inputted by the user and the scoring weight associated with each of the plurality of questions,
determine an overall evaluation score of the employee from the evaluation scores of the plurality of domains, and
associate the overall evaluation score with one of a plurality of employee categories, wherein each of the plurality of employee categories has a selected action associated therewith.

14. The non-transitory storage medium of claim 13, wherein the processor is further configured to accumulate the evaluation scores associated with the plurality of pre-determined questions to determine the overall evaluation score.

15. The non-transitory storage medium of claim 14, wherein the processor is further configured to associate a different scoring weight with each of the plurality of pre-determined questions.

16. The non-transitory storage medium of claim 13, wherein the processor is further configured to adjust the scoring weight associated with one or more questions based on data from the employee assessment unit and based on one or more evaluation parameters
